(19) United States
(12) Patent Application Publication
(10) Pub. No.: US 2024/0411750 A1
(43) Pub. Date: Dec. 12, 2024

(54) INTERACTIVE DATASET EXPLORATION AND PREPROCESSING

(71) Applicant: International Business Machines Corporation, Armonk, NY (US)

(72) Inventors: Vitobha Munigala, Secunderabad (IN); Shanmukha Chaitanya Guttula, Vijayawada (IN); Hima Patel, Bengaluru (IN)

(73) Assignee: International Business Machines Corporation, Armonk, NY (US)

(21) Appl. No.: 18/206,358

(22) Filed: Jun. 6, 2023

(51) Int. Cl. G06F 16/242; G06F 16/2455

(52) U.S. Cl. CPC G06F 16/243; G06F 16/2455

(57) ABSTRACT

A functionality intent is extracted from a natural language input, the functionality intent comprising an operation on a dataset. A portion of source code implementing the functionality intent is generated. Using a result of executing an executable version of the portion of source code on the dataset, a next functionality intent is recommended, the next functionality intent expressed in natural language form.

### BACKGROUND

The present invention relates generally to a method, system, and computer program product for dataset processing. More particularly, the present invention relates to a method, system, and computer program product for interactive dataset exploration and preprocessing.

Data science is the study of data to extract meaningful insights for business. A data scientist applies data science, using data to understand a phenomenon and help a team make better data-driven decisions. For example, a data scientist might analyze a dataset to find patterns or trends, create data models to perform forecasting, apply machine learning techniques to data, and report analysis or forecasting results.

### SUMMARY

The illustrative embodiments provide a method, system, and computer program product. An embodiment includes a method that extracts, from a natural language input, a functionality intent, the functionality intent comprising an operation on a dataset. An embodiment generates a portion of source code implementing the functionality intent. An embodiment recommends, using a result of executing an executable version of the portion of source code on the dataset, a next functionality intent, the next functionality intent expressed in natural language form.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for interactive dataset exploration and preprocessing in accordance with an illustrative embodiment;

FIG. 3 depicts a flow diagram of an example configuration for interactive dataset exploration and preprocessing in accordance with an illustrative embodiment;

FIG. 4 depicts an example of interactive dataset exploration and preprocessing in accordance with an illustrative embodiment;

FIG. 5 depicts a continued example of interactive dataset exploration and preprocessing in accordance with an illustrative embodiment;

FIG. 6 depicts a continued example of interactive dataset exploration and preprocessing in accordance with an illustrative embodiment;

FIG. 7 depicts a continued example of interactive dataset exploration and preprocessing in accordance with an illustrative embodiment;

FIG. 8 depicts a flowchart of an example process for interactive dataset exploration and preprocessing in accordance with an illustrative embodiment.

### DETAILED DESCRIPTION

The illustrative embodiments recognize that, before a data scientist can use a dataset effectively, the data scientist needs to understand characteristics of the dataset and the data in the dataset and select data analysis techniques, with appropriate parameters, that are best suited to those characteristics. This process is referred to as data exploration, and includes answering questions such which operations could be applied to a dataset, when a certain operation should be applied, how the operation should be performed (including algorithm and parameter selection), do results of an operation include a worrying pattern, how to characterize particular data points, and whether any important operations were missed. As well, dataset preprocessing is often required, for example to impute missing values, correct or ignore incorrect values, or simplify analysis of the dataset by ignoring or consolidating redundant data and data entries that are sufficiently similar to each other.

However, data exploration and preprocessing are often performed in an ad-hoc manner, without systematically performing particular steps. The amount and type of data exploration and preprocessing that are performed depend on the experience and skills of a particular data scientist. As a result, a new data scientist is likely to skip some steps, a data scientist moving from one subject area to another might be unfamiliar with subject area specific nuances, and even a senior data scientist might omit something. As well, it is difficult for all data scientists to keep up with new techniques in data science and implement those techniques in their work. Further, as each dataset comes with its own challenges and inherent patterns, data exploration varies from dataset to dataset, and static steps for data exploration do not work well. In addition, data exploration and preprocessing can be time intensive, without a clear end point. Presently available data analysis software packages include many features and capabilities, but do not provide guidance as to which features should be used in which circumstances or on which types of data.

Thus, the illustrative embodiments recognize that there is a need for a system that interactively guides a user through dataset-appropriate data exploration and preprocessing of a dataset.

The illustrative embodiments recognize that the presently available tools or solutions do not address these needs or provide adequate solutions for these needs. The illustrative embodiments used to describe the invention generally address and solve the above-described problems and other problems related to interactive dataset exploration and preprocessing.

An embodiment can be implemented as a software application. The application implementing an embodiment can be configured as a modification of an existing data analysis system, as a separate application that operates in conjunction with an existing data analysis system, a standalone application, or some combination thereof.

Particularly, some illustrative embodiments provide a method that extracts a functionality intent from a natural language input, generates a portion of source code implementing the functionality intent, and recommends, using a result of executing the portion of source code, a next functionality intent.

An embodiment extracts a functionality intent from a natural language input. In one embodiment, the natural language input is in text form or voice converted into text form, and the embodiment processes the input using a chatbot. A chatbot is a software application that implements a user interface mimicking human conversation through text or voice interactions. The user's input is referred to as a query, although the input need not be in the form of a question or be grammatically correct. An embodiment uses a presently available natural language processing technique to extract an intent (i.e., a user's goal for the query) from a query. For example, if a query is “are there any missing values in the data?”, a corresponding intent might be “missing values”. Presently available intent extraction techniques are not typically specific to a particular subject matter domain. Thus, an embodiment maps an identified intent to one of a plurality of known functionality intents. A functionality intent identifies a function the embodiment is able to perform on a dataset. For example, an embodiment might map an intent of “missing values” to the embodiment's function to impute, or fill in, missing values in a dataset.

Some natural language inputs include additional data used in performing the functionality intent, such as details of a particular query to be performed on a dataset, the code package and version to be used in performing a particular operation on a dataset, execution parameters to be used in performing a particular operation on a dataset, a user's answers to clarification or confirmation outputs from an embodiment, and the like. An embodiment uses a presently available natural language processing technique to extract additional data used in performing the functionality intent, and uses the results in performing the functionality intent or to select a different functionality intent for performance.

An embodiment extracts a functionality intent from an input portion of source code, using a presently available source code analysis technique. For example, a user might supply an input portion of source code that performs a specialized form of missing values imputation. Thus, an embodiment analyzes the input source code and determines that the code maps to the “missing values” functionality intent. Some source code inputs include additional data used in performing the functionality intent, such as the language used in the source code, the compiler or interpreter used to convert the source code to executable code, execution requirements or parameters of the source code, and the like.

An embodiment uses a presently available natural language processing technique to extract additional data used in performing the functionality intent, and uses the results in performing the functionality intent or to select a different functionality intent for performance. Another embodiment extracts a functionality intent from an input portion of executable code, using a presently available code analysis technique.

An embodiment generates an implementation of a functionality intent. One embodiment uses an implementation from a library of previously implemented functionalities maintained by the embodiment, and if necessary adapts the previously used implementation to meet a specification or parameter submitted by a user or needed for execution in a particular environment. For example, a previously implemented implementation might need to be recompiled to execute in a different processor or a different operating system environment, be changed to a different implementation version, execute for a user-specified number of iterations or using a specified set of parameter settings, and the like. Another embodiment starts with source code received from a user, and if necessary adapts the source code to meet a specification or parameter submitted by a user or needed for execution in a particular environment. An embodiment stores a generated implementation of a functionality intent in the library of implemented functionalities, for later re-use.

An embodiment executes the generated implementation on a dataset and reports a result of executing the implementation on the dataset. An embodiment also logs the execution and result in a log of executed implementations, for the user's later reference and for use in recommending further operations on the dataset.

If a generated implementation includes a metric with a numeric result, an embodiment reports a result of executing the implementation as a score. Some non-limiting examples of metrics with a numeric result are a count or percentage of missing values in a portion of the dataset (e.g., 52 missing values out of 50,000 rows) and a class imbalance in the dataset (e.g., 1000 rows in Class1 and 9000 rows in Class 2). One embodiment uses the numeric result as the score. Another embodiment converts the numeric result to a score within a predefined range (e.g., 0 to 1 or a percentage). An embodiment further classifies the score into two or more categories, based on the score's relationship to thresholds defining the categories, and reports the score's category to a user. For example, an embodiment might classify a result of 52 missing values out of 50,000 rows into a “needs remediation” category because the missing value percentage is above a predefined threshold value, and report this category to a user.

In an embodiment, one generated implementation analyzes a dataset for erroneous data, and characterizes the erroneous data points according to one or more metrics. Some non-limiting examples of metrics used to characterize erroneous data points include data points with the same semantics or semantics with above a threshold similarity to each other, the most diverse points, a class wise shift or distribution, a data point's contrast with neighboring points, points with a complexity above and below a predefined threshold value, points with a confidence above and below a predefined threshold value, and the like. Another generated implementation characterizes the erroneous data points according to a syntactic pattern. For example, erroneous numeric data points might all be negative numbers, erroneous strings might satisfy a particular regular expression (regex), or erroneous timestamps might all be in July or on Saturdays. Another generated implementation characterizes the erroneous data points according to an association between the erroneous data points' column and another data column. For example, data in the Temperature column might be missing during July.

An embodiment reports a result using one or more of natural language text, natural language text converted into voice form, a still image (e.g., a graph or data table), a video animation (e.g., a graph or table with different portions highlighted with explanatory text), another form, or a combination. For example, if the result includes missing or erroneous values, an embodiment might highlight a column (in a table) having missing values or highlight selected erroneous values. To determine parameters governing result reporting, an embodiment starts with a set of defaults and learns from the parameters supplied by the current user or previous users.

An embodiment uses a result of executing the portion of source code and the log of executed implementations to recommend a next functionality intent to a user. For example, if a result of executing the portion of source code identifies issues with data in the dataset, an embodiment reports the issues to the user and suggests a corresponding remediation. One embodiment uses an n-gram model, a presently available sequence modeling technique. In particular, to train the model an embodiment uses previous users' history of operations on other datasets to generates an n-gram table which includes an effect of an operation on a dataset given a history of previous set of operations users applied to the same dataset. An embodiment uses the n-gram table to recommend an operation that increases or decreases a set of available operations on the dataset by more than a threshold amount. Thus, if the log of executed implementations is missing an operation that most users in the training data performed, an embodiment recommends performing that operation. For example, if an executed implementation found missing data values, an embodiment might recommend imputing the missing values.

An embodiment receives a user's response to the recommended next functionality intent, and processes the user's response in a manner described herein.

The manner of interactive dataset exploration and preprocessing described herein is unavailable in the presently available methods in the technological field of endeavor pertaining to data analysis using a computing device. A method of an embodiment described herein, when implemented to execute on a device or data processing system, comprises substantial advancement of the functionality of that device or data processing system in extracting, from a natural language input, a functionality intent, generating a portion of source code implementing the functionality intent, and recommending, using a result of executing the portion of source code, a next functionality intent.

The illustrative embodiments are described with respect to certain types of intents, functionalities, results, analyses, dataset operations, thresholds, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

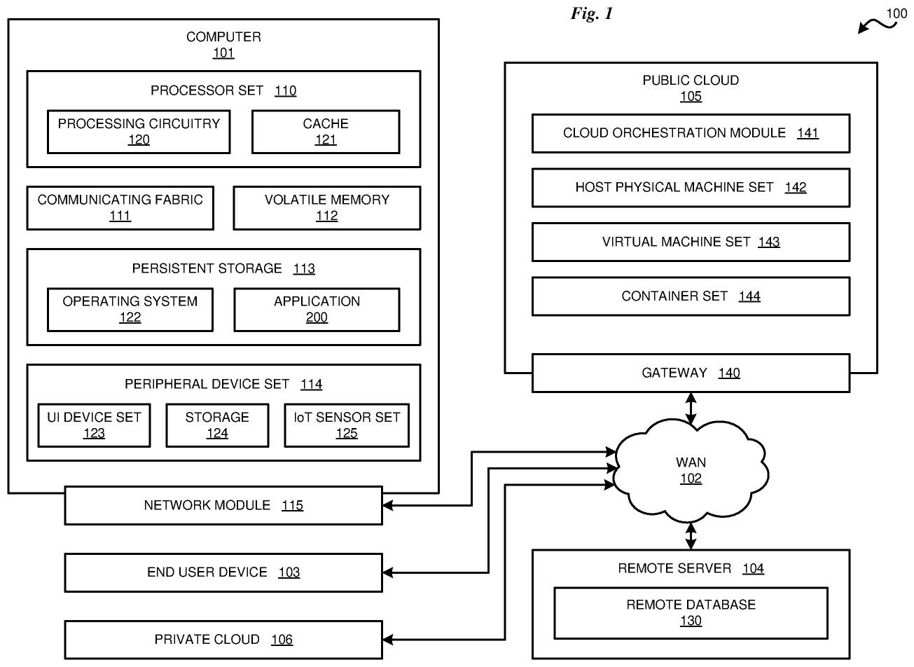

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements an interactive dataset exploration and preprocessing embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated. In addition, the dataset being analyzed need not reside on the same system as application 200.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

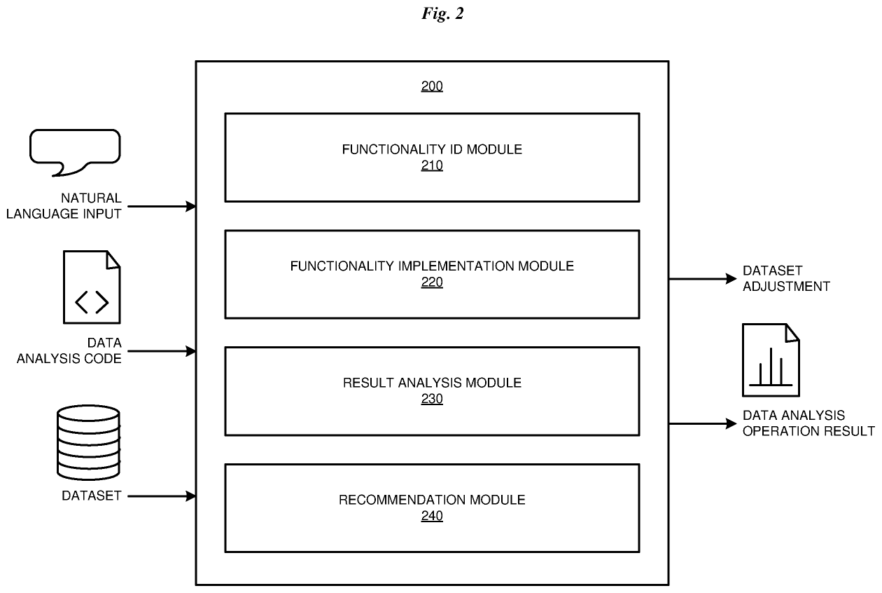

With reference to FIG. 2, this figure depicts a block diagram of an example configuration for interactive dataset exploration and preprocessing in accordance with an illustrative embodiment. Application 200 is the same as application 200 in FIG. 1.

Functionality identification (ID) module 210 extracts a functionality intent from a natural language input. In one implementation of module 210, the natural language input is in text form or voice converted into text form, and module 210 processes the input using a chatbot. The user's input is referred to as a query, although the input need not be in the form of a question or be grammatically correct. Module 210 uses a presently available natural language processing technique to extract an intent (i.e., a user's goal for the query) from a query. For example, if a query is “are there any missing values in the data?”, a corresponding intent might be “missing values”. Presently available intent extraction techniques are not typically specific to a particular subject matter domain. Thus, module 210 maps an identified intent to a functionality intent. A functionality intent identifies a function the embodiment is able to perform on a dataset. For example, an embodiment might map an intent of “missing values” to the embodiment's function to impute, or fill in, missing values in a dataset.

Some natural language inputs include additional data used in performing the functionality intent, such as details of a particular query to be performed on a dataset, the code package and version to be used in performing a particular operation on a dataset, execution parameters to be used in performing a particular operation on a dataset, a user's answers to clarification or confirmation outputs from an embodiment, and the like. Module 210 uses a presently available natural language processing technique to extract additional data used in performing the functionality intent, and uses the results in performing the functionality intent or to select a different functionality intent for performance.

Module 210 extracts a functionality intent from an input portion of source code, using a presently available source code analysis technique. For example, a user might supply an input portion of source code that performs a specialized form of missing values imputation. Thus, module 210 analyzes the input source code and determines that the code maps to the “missing values” functionality intent. Some source code inputs include additional data used in performing the functionality intent, such as the language used in the source code, the compiler or interpreter used to convert the source code to executable code, execution requirements or parameters of the source code, and the like. Module 210 uses a presently available natural language processing technique to extract additional data used in performing the functionality intent, and uses the results in performing the functionality intent or to select a different functionality intent for performance. Another implementation of module 210 extracts a functionality intent from an input portion of executable code, using a presently available code analysis technique.

Functionality implementation module 220 generates an implementation of a functionality intent. One implementation of module 220 uses an implementation from a library of previously implemented functionalities maintained by the embodiment, and if necessary adapts the previously used implementation to meet a specification or parameter submitted by a user or needed for execution in a particular environment. For example, a previously implemented implementation might need to be recompiled to execute in a different processor or a different operating system environment, be changed to a different implementation version, execute for a user-specified number of iterations or using a specified set of parameter settings, and the like. Another implementation of module 220 starts with source code received from a user, and if necessary adapts the source code to meet a specification or parameter submitted by a user or needed for execution in a particular environment. Module 220 stores a generated implementation of a functionality intent in the library of implemented functionalities, for later re-use.

Application 200 executes the generated implementation on a dataset and result analysis module 230 reports a result of executing the implementation on the dataset. Module 230 also logs the execution and result in a log of executed implementations, for the user's later reference and for use in recommending further operations on the dataset.

If a generated implementation includes a metric with a numeric result, module 230 reports a result of executing the implementation as a score. Some non-limiting examples of metrics with a numeric result are a count or percentage of missing values in a portion of the dataset (e.g., 52 missing values out of 50,000 rows) and a class imbalance in the dataset (e.g., 1000 rows in Class1 and 9000 rows in Class 2). One implementation of module 230 uses the numeric result as the score. Another implementation of module 230 converts the numeric result to a score within a predefined range (e.g., 0 to 1 or a percentage). Module 230 further classifies the score into two or more categories, based on the score's relationship to thresholds defining the categories, and reports the score's category to a user. For example, module 230 might classify a result of 52 missing values out of 50,000 rows into a “needs remediation” category because the missing value percentage is above a predefined threshold value, and report this category to a user.

One generated implementation analyzes a dataset for erroneous data, and characterizes the erroneous data points according to one or more metrics. Some non-limiting examples of metrics used to characterize erroneous data points include data points with the same semantics or semantics with above a threshold similarity to each other, the most diverse points, a class wise shift or distribution, a data point's contrast with neighboring points, points with a complexity above and below a predefined threshold value, points with a confidence above and below a predefined threshold value, and the like. Another generated implementation characterizes the erroneous data points according to a syntactic pattern. For example, erroneous numeric data points might all be negative numbers, erroneous strings might satisfy a particular regular expression (regex), or erroneous timestamps might all be in July or on Saturdays. Another generated implementation characterizes the erroneous data points according to an association between the erroneous data points' column and another data column. For example, data in the Temperature column might be missing during July.

Module 230 reports a result using one or more of natural language text, natural language text converted into voice form, a still image (e.g., a graph or data table), a video animation (e.g., a graph or table with different portions highlighted with explanatory text), another form, or a combination. For example, if the result includes missing or erroneous values, module 230 might highlight a column (in a table) having missing values or highlight selected erroneous values. To determine parameters governing result reporting, module 230 starts with a set of defaults and learns from the parameters supplied by the current user or previous users.

Recommendation module 240 uses a result of executing the portion of source code and the log of executed implementations to recommend a next functionality intent to a user. For example, if a result of executing the portion of source code identifies issues with data in the dataset, application 200 reports the issues to the user and suggests a corresponding remediation. One implementation of module 240 uses an n-gram model, a presently available sequence modeling technique. In particular, to train the model module 240 uses previous users' history of operations on other datasets to generates an n-gram table which includes an effect of an operation on a dataset given a history of previous set of operations users applied to the same dataset. Module 240 uses the n-gram table to recommend an operation that increases or decreases a set of available operations on the dataset by more than a threshold amount. Thus, if the log of executed implementations is missing an operation that most users in the training data performed, module 240 recommends performing that operation. For example, if an executed implementation found missing data values, module 240 might recommend imputing the missing values.

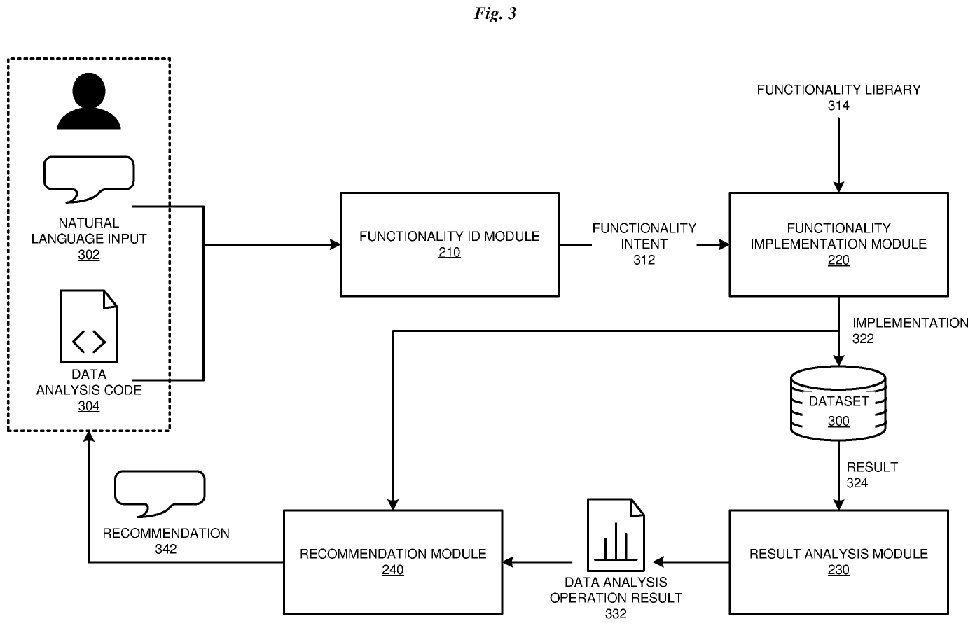

With reference to FIG. 3, this figure depicts a flow diagram of an example configuration for interactive dataset exploration and preprocessing in accordance with an illustrative embodiment. The flow diagram can be executed using application 200 in FIG. 2. Functionality ID module 210, functionality implementation module 220, result analysis module 230, and recommendation module 240 are the same as functionality ID module 210, functionality implementation module 220, result analysis module 230, and recommendation module 240 in FIG. 2.

Functionality identification (ID) module 210 extracts functionality intent 312 from one of natural language input 302, data analysis code 304, or a combination of the two. Functionality implementation module 220 generates implementation 322 of functionality intent 312, using functionality library 314. Application 200 executes implementation 322 on dataset 300, generating result 324. From result 324, result analysis module 230 reports data analysis result 332, using one or more of natural language text, natural language text converted into voice form, a still image (e.g., a graph or data table), a video animation (e.g., a graph or table with different portions highlighted with explanatory text), another form, or a combination. Recommendation module 240 uses data analysis result 332 and the log of executed implementations to recommend recommendation 342 to a user.

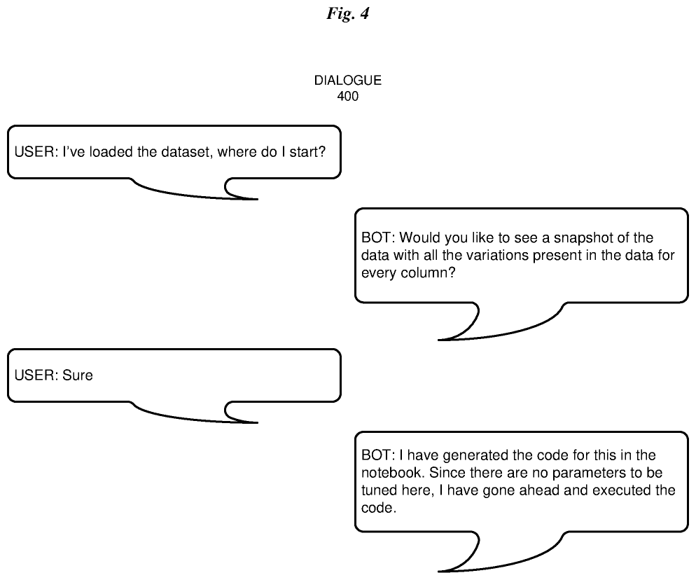

With reference to FIG. 4, this figure depicts an example of interactive dataset exploration and preprocessing in accordance with an illustrative embodiment. The example can be executed using application 200 in FIG. 2.

In particular, dialogue 400 depicts a user's asking for a recommendation of where to start analyzing a dataset, and application 200 (“Bot”)'s responses.

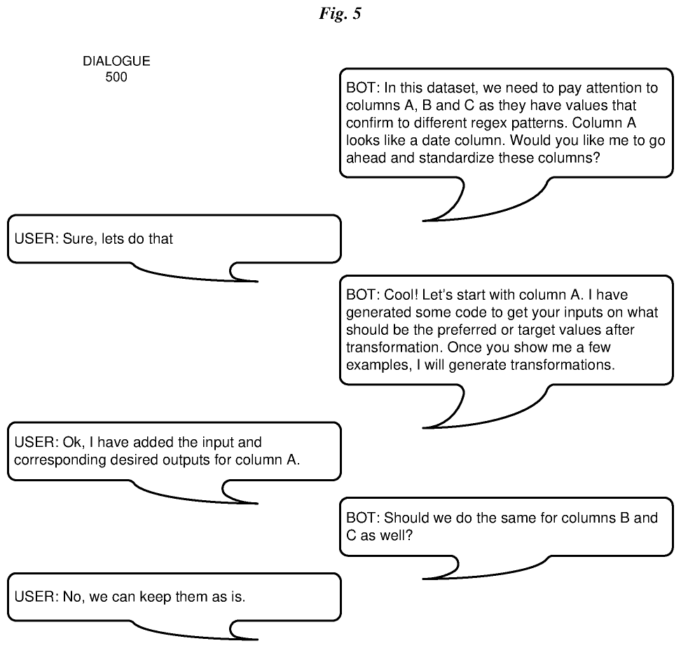

With reference to FIG. 5, this figure depicts a continued example of interactive dataset exploration and preprocessing in accordance with an illustrative embodiment.

In particular, dialogue 500 depicts application 200 (“Bot”)'s reporting of results of analyzing a dataset for nonstandard data and recommendations of what the user should do next, in an interactive manner.

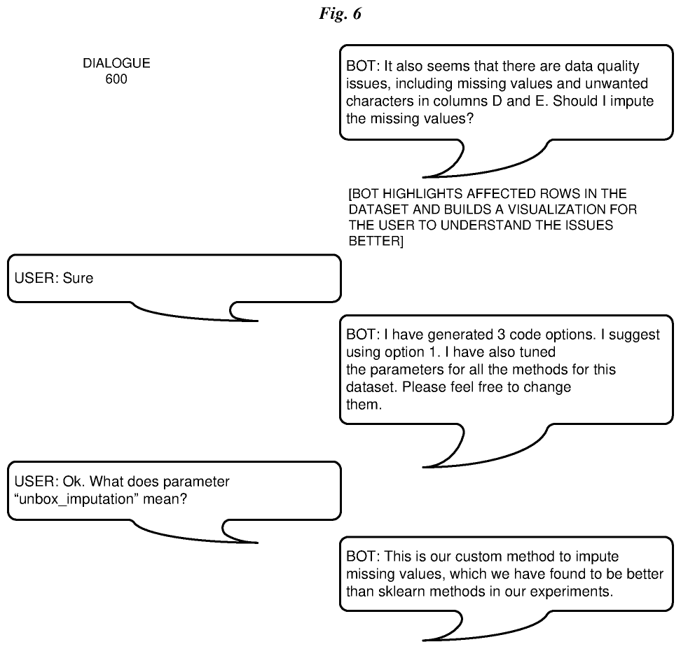

With reference to FIG. 6, this figure depicts a continued example of interactive dataset exploration and preprocessing in accordance with an illustrative embodiment.

In particular, dialogue 600 depicts application 200 (“Bot”)'s reporting of results of analyzing a dataset for missing values and unwanted characters and recommendations of what the user should do next, in an interactive manner. An entry in [ ] reflects a summary of an operation. Application 200 also answer's the user's question on the meaning of a particular analysis parameter.

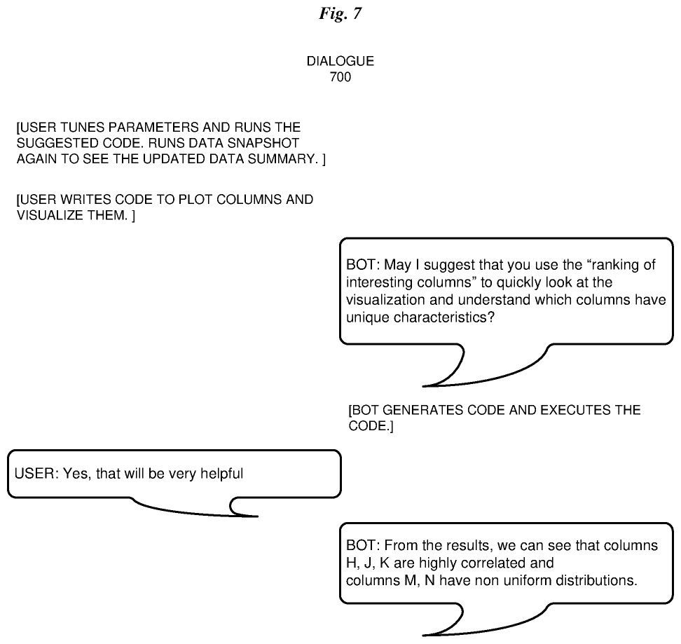

With reference to FIG. 7, this figure depicts a continued example of interactive dataset exploration and preprocessing in accordance with an illustrative embodiment.

In particular, dialogue 700 depicts the user's next steps, as well as application 200 (“Bot”)'s recommendation of another data analysis step, and the results of that step. An entry in [ ] reflects a summary of an operation.

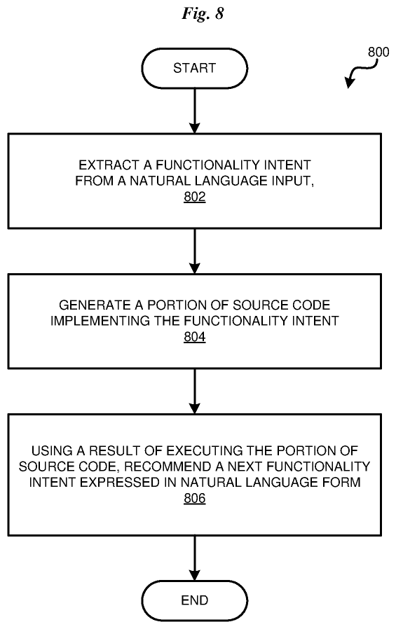

With reference to FIG. 8, this figure depicts a flowchart of an example process for interactive dataset exploration and preprocessing in accordance with an illustrative embodiment. Process 800 can be implemented in application 200 in FIG. 2.

In block 802, the application extracts a functionality intent from a natural language input. In block 804, the application generates a portion of source code implementing the functionality intent. In block 806, the application, using a result of executing the portion of source code, recommends a next functionality intent expressed in natural language form. Then the application ends.

Thus, a computer implemented method, system or apparatus, and computer program product are provided in the illustrative embodiments for interactive dataset exploration and preprocessing and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
extracting, from a natural language input, a functionality intent, the functionality intent comprising an operation on a dataset;
generating a portion of source code implementing the functionality intent; and
recommending, using a result of executing an executable version of the portion of source code on the dataset, a next functionality intent, the next functionality intent expressed in natural language form.

2. The computer-implemented method of claim 1, further comprising:
extracting, from an input portion of source code, a second functionality intent, the second functionality intent comprising a second operation on the dataset;
adapting the input portion of source code to implement the second functionality intent, the adapting resulting in an adapted version of the input portion; and
executing, on the dataset, an executable version of the adapted version.

3. The computer-implemented method of claim 1, wherein extracting the functionality intent comprises mapping an intent extracted from the natural language input to one of plurality of known functionality intents.

4. The computer-implemented method of claim 1, wherein generating the portion of source code comprises adapting a stored portion of source code to implement the functionality intent, the stored portion of source code comprising a previously implemented functionality intent.

5. The computer-implemented method of claim 1, wherein the next functionality intent comprises a functionality intent not yet logged in a log of executed functionality intents on the dataset.

6. The computer-implemented method of claim 1, wherein the functionality intent comprises a missing value identification operation, the result comprises an identification of a missing value, and the next functionality intent comprises a missing value imputation operation.

7. A computer program product comprising one or more computer readable storage medium, and program instructions collectively stored on the one or more computer readable storage medium, the program instructions executable by a processor to cause the processor to perform operations comprising:
extracting, from a natural language input, a functionality intent, the functionality intent comprising an operation on a dataset;
generating a portion of source code implementing the functionality intent; and
recommending, using a result of executing an executable version of the portion of source code on the dataset, a next functionality intent, the next functionality intent expressed in natural language form.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
extracting, from an input portion of source code, a second functionality intent, the second functionality intent comprising a second operation on the dataset;
adapting the input portion of source code to implement the second functionality intent, the adapting resulting in an adapted version of the input portion; and
executing, on the dataset, an executable version of the adapted version.

11. The computer program product of claim 7, wherein extracting the functionality intent comprises mapping an intent extracted from the natural language input to one of plurality of known functionality intents.

12. The computer program product of claim 7, wherein generating the portion of source code comprises adapting a stored portion of source code to implement the functionality intent, the stored portion of source code comprising a previously implemented functionality intent.

13. The computer program product of claim 7, wherein the next functionality intent comprises a functionality intent not yet logged in a log of executed functionality intents on the dataset.

14. The computer program product of claim 7, wherein the functionality intent comprises a missing value identification operation, the result comprises an identification of a missing value, and the next functionality intent comprises a missing value imputation operation.

15. A computer system comprising a processor and one or more computer readable storage media, and program instructions collectively stored on the one or more computer readable storage media, the program instructions executable by the processor to cause the processor to perform operations comprising:
extracting, from a natural language input, a functionality intent, the functionality intent comprising an operation on a dataset;
generating a portion of source code implementing the functionality intent; and
recommending, using a result of executing an executable version of the portion of source code on the dataset, a next functionality intent, the next functionality intent expressed in natural language form.

16. The computer system of claim 15, further comprising:
extracting, from an input portion of source code, a second functionality intent, the second functionality intent comprising a second operation on the dataset;
adapting the input portion of source code to implement the second functionality intent, the adapting resulting in an adapted version of the input portion; and
executing, on the dataset, an executable version of the adapted version.

17. The computer system of claim 15, wherein extracting the functionality intent comprises mapping an intent extracted from the natural language input to one of plurality of known functionality intents.

18. The computer system of claim 15, wherein generating the portion of source code comprises adapting a stored portion of source code to implement the functionality intent, the stored portion of source code comprising a previously implemented functionality intent.

19. The computer system of claim 15, wherein the next functionality intent comprises a functionality intent not yet logged in a log of executed functionality intents on the dataset.

20. The computer system of claim 15, wherein the functionality intent comprises a missing value identification operation, the result comprises an identification of a missing value, and the next functionality intent comprises a missing value imputation operation.
